(19) United States
(12) Patent Application Publication
(10) Pub. No.: US 2023/0057968 A1
(43) Pub. Date: Feb. 23, 2023

(54) USER EQUIPMENT, NON-PUBLIC NETWORK AUTHENTICATION-AUTHORIZATION-ACCOUNTING SERVER, AUTHENTICATION SERVER FUNCTION ENTITY

(71) Applicant: Sony Group Corporation, Tokyo (JP)

(72) Inventors: Vivek SHARMA, Basingstoke (GB); Hideji WAKABAYASHI, Basingstoke (GB)

(73) Assignee: Sony Group Corporation, Tokyo (JP)

(21) Appl. No.: 17/792,409

(22) PCT Filed: Jan. 26, 2021
(86) PCT No.: PCT/EP2021/051750

§ 371 Date: Jul. 13, 2022

(30) Foreign Application Priority Data
Jan. 31, 2020 (EP) 20154959.9

(51) Int. Cl. H04L 9/40; H04W 12/06; H04W 12/033

(52) U.S. Cl. CPC H04L 63/0892; H04W 12/06; H04W 12/033

(57) ABSTRACT

A user equipment for a mobile telecommunications system, including circuitry configured to: communicate with a non-public network authentication-authorization-accounting server and initiate a registration procedure with the mobile telecommunications system; and provide an authentication interface between the non-public network authentication-authorization-accounting server and an authentication server function entity in the mobile tele-communications system.

### TECHNICAL FIELD

The present disclosure generally pertains to user equipments, non-public network authentication-authorization-accounting servers and authentication server function entities for a mobile telecommunications system.

### TECHNICAL BACKGROUND

Several generations of mobile telecommunications systems are known, e.g. the third generation (“3G”), which is based on the International Mobile Telecommunications-2000 (IMT-2000) specifications, the fourth generation (“4G”), which provides capabilities as defined in the International Mobile Telecommunications-Advanced Standard (IMT-Advanced Standard), and the current fifth generation (“5G”), which is under development and which might be put into practice in the year 2020.

A candidate for providing the requirements of 5G is the so-called Long Term Evolution (“LTE”), which is a wireless communications technology allowing high-speed data communications for mobile phones and data terminals and which is already used for 4G mobile telecommunications systems. Other candidates for meeting the 5G requirements are termed New Radio (NR) Access Technology Systems. An NR can be based on LTE technology, just as some aspect of LTE was based on previous generations of mobile communications technology.

LTE is based on the GSM/EDGE (“Global System for Mobile Communications”/“Enhanced Data rates for GSM Evolution” also called EGPRS) of the second generation (“2G”) and UMTS/HSPA (“Universal Mobile Telecommunications System”/“High Speed Packet Access”) of the third generation (“3G”) network technologies.

LTE is standardized under the control of 3GPP (“3rd Generation Partnership Project”) and there exists a successor LTE-A (LTE Advanced) allowing higher data rates than the basic LTE and which is also standardized under the control of 3GPP.

For the future, 3GPP plans to further develop LTE-A such that it will be able to fulfill the technical requirements of 5G.

As the 5G system may be based on LTE-A or NR, respectively, it is assumed that specific requirements of the 5G technologies will, basically, be dealt with by features and methods which are already defined in the LTE-A and NR standard documentation.

Moreover, 3GPP specified a support of non-public networks, for example, in 3GPP TS 22.261 (V 17.1.0) and studied management aspects of non-public networks e.g. in 3GPP TS 28.807 (V 0.3.0). Non-public networks are intended for the sole use of a private entity such as an enterprise, and may be deployed in a variety of configurations, utilizing both virtual and physical elements. Specifically, they may be deployed as completely standalone networks, they may be hosted by a public land mobile network (“PLMN”), or they may be offered as a slice of a PLMN.

In 3GPP TS 33.501 (V 16.1.0) security procedures for authentication and authorization between a user equipment and the mobile telecommunications system are specified and, in particular, authentication procedures between a user equipment and a non-public network.

Although there exist techniques for an authentication of a user equipment in non-public networks, it is generally desirable to improve the existing techniques.

### SUMMARY

According to a first aspect the disclosure provides a user equipment for a mobile telecommunications system, comprising circuitry configured to:
communicate with a non-public network authentication-authorization-accounting server and initiate a registration procedure with the mobile telecommunications system; and
provide an authentication interface between the non-public network authentication-authorization-accounting server and an authentication server function entity in the mobile telecommunications system.

According to a second aspect the disclosure provides a non-public network authentication-authorization-accounting server, comprising circuitry configured to:
communicate with an associated user equipment for a mobile telecommunications system; and
receive information from the associated user equipment, wherein the associated user equipment received the data packets from the mobile telecommunications system via an authentication interface between the non-public network authentication-authorization-accounting server and an authentication server function entity in the mobile telecommunications system provided by the associated user equipment.

According to a third aspect the disclosure provides a non-public network authentication-authorization-accounting server, comprising circuitry configured to:
generate and encrypt an extended master session key based on a pre-shared non-public network authentication-authorization-accounting server ID of the non-public network authentication-authorization-accounting server; and
transfer the generated and encrypted extended master session key to an authentication server function entity via a wired interface.

According to a fourth aspect the disclosure provides a non-public network authentication-authorization-accounting server, comprising circuitry configured to:
receive a public key from an authentication server function entity; and
generate and encrypt an extended master session key based on the received public key and to transfer the extended master session key to the authentication server function entity via a wired interface.

According to a fifth aspect the disclosure provides a non-public network authentication-authorization-accounting server, comprising circuitry configured to:
obtain a predetermined secret key stored in a secure memory in the non-public network authentication-authorization-accounting server in advance;
generate and encrypt an extended master session key based on the predetermined secret key; and
transfer the generated and encrypted extended master session key to an authentication server function entity via a wired interface.

According to a sixth aspect the disclosure provides an authentication server function entity for a mobile telecommunications system, comprising circuitry configured to:
register a user equipment associated with a non-public network authentication-authorization-accounting server to the mobile telecommunications system; and
receive a signaling from the user equipment indicating that the user equipment is associated with the non-public network authentication-authorization-accounting server, wherein an authentication interface between the non-public network authentication-authorization-accounting server and the authentication server function entity is provided when the user equipment is authenticated and authorized as the user equipment associated with the non-public network authentication-authorization-accounting server in response to the signaling.

According to a seventh aspect the disclosure provides an authentication server function entity for a mobile telecommunications system, comprising circuitry configured to:
receive an extended master session key generated and encrypted by a non-public network authentication-authorization-accounting server via a wired interface; and
decrypt the encrypted extended master session key based on a pre-shared non-public network authentication-authorization-accounting server ID of the non-public network authentication-authorization-accounting server.

According to an eight aspect the disclosure provides an authentication server function entity for a mobile telecommunications system, comprising circuitry configured to:
generate a public key and a private key; and
transmit the public key to a non-public network authentication-authorization-accounting server via a wired interface, wherein the authentication server function entity holds the private key.

According to a ninth aspect the disclosure provides an authentication server function entity for a mobile telecommunications system, comprising circuitry configured to:
obtain a predetermined secret key stored in a secure memory in the authentication server function entity in advance;
receive an extended master session key generated and encrypted by a non-public network authentication-authorization-accounting server via a wired interface; and
decrypt the encrypted extended master session key based on the predetermined secret key.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates schematically a first embodiment of a mobile telecommunications system including a non-public network;

FIG. 2 illustrates schematically a first embodiment of a mobile telecommunications system including a non-public network including a user equipment in a state of establishing an authentication interface for the non-public network;

FIG. 3 illustrates in a state diagram an embodiment for providing an authentication interface for a non-public network;

FIG. 4. illustrates schematically a second embodiment of a mobile telecommunications system including a non-public network including a user equipment for providing an authentication interface for the non-public network;

FIG. 5 illustrates schematically an embodiment of a mobile telecommunications system including a non-public network including a wired interface between a non-public network authentication-authorization-accounting server and an authentication server function entity;

FIG. 6 illustrates in a state diagram a first embodiment of a transfer of an extended master session key from a non-public network authentication-authorization-accounting server to an authentication server function entity via a wired interface;

FIG. 7 illustrates in a state diagram a second embodiment of a transfer of an extended master session key from a non-public network authentication-authorization-accounting server to an authentication server function entity via a wired interface;

FIG. 8 illustrates in a block diagram an embodiment of a user equipment, a base station, an authentication-authorization-accounting server and an authentication server function entity; and

FIG. 9 illustrates in a block diagram a multi-purpose computer which can be used for implementing a user equipment, a base station, an authentication-authorization-accounting server and an authentication server function entity.

### DETAILED DESCRIPTION OF EMBODIMENTS

Before a detailed description of the embodiments under reference of FIG. 2 is given, general explanations are made.

As mentioned in the outset, in general, several generations of mobile telecommunications systems are known, e.g. the third generation (“3G”), which is based on the International Mobile Telecommunications-2000 (IMT-2000) specifications, the fourth generation (“4G”), which provides capabilities as defined in the International Mobile Telecommunications-Advanced Standard (IMT-Advanced Standard), and the current fifth generation (“5G”), which is under development and which might be put into practice this year.

One of the candidates for meeting the 5G requirements are termed New Radio (“NR”) Access Technology Systems. Some aspects of NR can be based on LTE technology, in some embodiments, just as some aspects of LTE were based on previous generations of mobile communications technology.

Moreover, 3GPP specified a support of non-public networks, for example, in 3GPP TS 22.261 (V 17.1.0) and studied management aspects of non-public networks e.g. in 3GPP TS 28.807 (V 0.3.0). Non-public networks are intended for the sole use of a private entity such as an enterprise, and may be deployed in a variety of configurations, utilizing both virtual and physical elements. Specifically, they may be deployed as completely standalone networks, they may be hosted by a public land mobile network (“PLMN”), or they may be offered as a slice of a PLMN.

In some embodiments, a non-public network is a network which is deployed outside of a mobile operator network (“MNO”) and it has two deployment options:
the NPN is deployed as a Standalone NPN (“SNPN”); and
the NPN is deployed as a part of the MNO as a Non-Standalone NPN (“NSNPN”).

In some embodiments, an NPN is hosted by a public network (NSNPN), i.e. a public mobile telecommunications system, which can be realized by implementing a network slice or an access point name (“APN”) for the NPN in the public network (“PN”). In such embodiments, the NPN deployment requires a cell to broadcast a CAG (“Closed Access Group”) ID, which is also referred to as a public network integrated-NPN (“PNI-NPN”). In some embodiments, the NPN and the public network share parts of the radio access network (“RAN”), control plane functions (e.g. authentication server functions (“AUSF”)) or user plane functions (“UPF”). As mentioned, this may be realized by implementing a network slice or the like. In such embodiments, a public network customer and the corresponding user equipment (“UE”) is allowed to use the RAN of the NPN (for example a base station of the NPN) for control plane functions of the public network. In some embodiments, an NPN customer is also a public network customer and is allowed to register with both networks.

In a case of a SNPN, in some embodiments, a cell broadcasts a PLMN (“Public Land Mobile Network”) ID and an NPN ID. In such embodiments, the PLMN ID and NPN ID may not be unique, since the SNPN is supposed to be a secluded deployment such that no interaction is foreseen between a public network, but cell resources may be shared between both public and non-public network.

It is foreseen that in 3GPP Release-16 a cell selection and reselection behavior in a SNPN cell deployment and in NSNPN cell deployments, i.e. where an operator cell is shared and hosts the NPN cell function as well, is specified.

In 3GPP TS 33.501 (V 16.1.0) security procedures for authentication and authorization between a user equipment and the mobile telecommunications system are specified and, in particular, authentication procedures between a user equipment and a non-public network.

Generally, in some embodiments, an authentication and key agreement procedure may enable mutual authentication between a user equipment and a network, which may be based on an extensible authentication protocol (“EAP”) framework. Typically, EAP-AKA is the baseline for 3GPP, but other methods like EAP-AKA’ and TLS are also specified. The EAP framework includes roles, for example, an EAP peer, an EAP pass-through authenticator, and an EAP server (backend authentication server). The EAP pass-through authenticator may not examine an EAP data packet and, thus, may not need to implement any authentication method (e.g. EAP-AKA’ (EAP-authentication and key agreement protocol') or EAP-TLS (EAP-transport layer security)). The EAP peer and EAP server must implement an authentication method.

In some embodiments, a non-public network authentication-authorization-accounting (“NPN AAA”) server is involved in the authentication of a user equipment at the non-public network, i.e. the user equipment authenticates at the NPN AAA server, for example, for access to services offered by the NPN. An authentication-authorization-accounting (“AAA”) server is generally known to the skilled person and, thus, a detailed description of it is omitted. In such embodiments, the EAP server role may either reside on an authentication server function (“AUSF”) entity or the NPN AAA server.

It has been recognized that the authentication method for authenticating a user equipment at the (Non-Standalone) NPN may impact the EAP peer (i.e. UE) and the EAP server (i.e. AUSF entity or NPN AAA server) and the key hierarchy (e.g. specified in 3GPP TS 33.501 (V 16.1.0)), since different authentication methods typically require different credentials.

Generally, in 3GPP Rel-16 the security framework has already specified the support of (5G-)-AKA, EAP-AKA’ and EAP-TLS methods. All these options assume that the EAP server will reside in the core network of the mobile telecommunications system. However, NPN deployments may have both options i.e. NPN AAA server integrated with an AUSF entity in mobile network operator (“MNO”) core network or integrated with the NPN and NPN AAA (EAP server) physically and logically residing within the NPN, in some embodiments. Any UE credentials in an NPN deployment can be based on either certificates or not-certificate based, in some embodiments.

It has been recognized that certificate-based credentials, in some embodiments, can be handled by the existing specifications by support of EAP-TLS (a certificate-based approach with an NPN AAA server may not offer any advantages) and for non-certificate-based credentials without an NPN AAA server EAP-TTLS (EAP-tunneled transport layer security) may be a suitable authentication method (a change required to 5G networks may be to encapsulate first phase and second phase EAP messages in NAS (“Non-Access Stratum”) signaling).

Moreover, for non-certificate-based credentials with an NPN AAA server, in some embodiments, the following issues have been recognized:
interface between (5G) core network and NPN AAA server;
transfer of an (extended) master session key (“(E)MSK”) from the NPN AAA server to the AUSF entity if EAP server resides on the NPN AAA server; and
support of RADIUS (“Remote Authentication Dial In User Service”) or DIAMETER protocol if EAP server resides on AUSF.

In some embodiments, the authentication method between a UE and an NPN AAA server is EAP-(T)TLS (“EAP-(tunneled) transport layer security”) and the UE with non-certificate-based credentials initiates authentication procedure at the NPN AAA server on which the EAP server role resides.

In such embodiments, it has been recognized that, as mentioned above, an (extended) master session key (“(E)MSK”) needs to be transferred in a secure way to the AUSF entity for further key derivation, since the (E)MSK is derived by the UE and the NPN AAA server. Hence, in such embodiments, an authentication interface between the NPN AAA server and the AUSF entity is required.

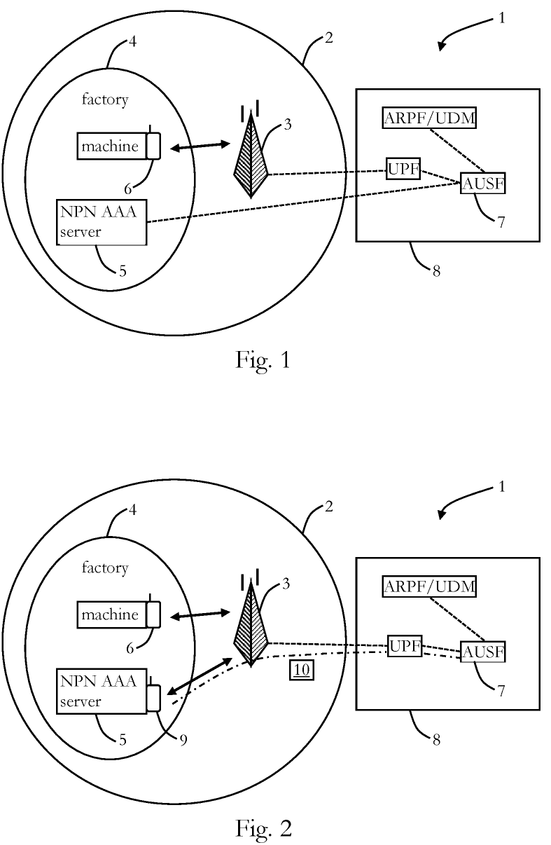

An example scenario is discussed in the following under reference of FIG. 1, which illustrates schematically a first embodiment of a mobile telecommunications system 1 including a non-public network 4.

The mobile telecommunications system 1 is provided by a mobile network operator (“MNO”) and includes a NR radio access network (RAN) including a cell 2, which is established by an NR eNodeB 3 (also referred to as gNB (next generation eNodeB)).

In the cell 2, a non-public network (NPN) 4 is deployed, for example, in a factory, which can be, for example, established by a network slice, as mentioned above for NSNPN case. The NPN 4 hosts its own non-public network authentication-authorization-accounting (NPN AAA) server 5 for authentication of a non-public network user equipment (NPN UE) 6, which can be or mounted to, for example, a machine. The NPN UE 6 can communicate with the gNB 3 in order to authenticate at the NPN AAA server 5 via an AUSF entity 7 in a core network 8.

In an example scenario, the factory, i.e. the NPN 4, owns credentials for its machines, i.e. the (machine) NPN UE 6, and would like to use these credentials for security purposes. Assuming these credentials are similar to a “K” value, which may be stored in a SIM (“Subscriber Identity Module”) card and ARPF (“Authentication credential Repository and Processing Function”)/UDM (“Unified Data Management”) in the core network 8, then the (onsite) NPN AAA server 5 may not require any credentials to be shared with the MNO (trust relationship between two business entities, i.e. MNO and the factory owner, may not develop easily and factory owner may prefer switching the MNO supplier in future without the hassle of changing SIM cards inside each machine on the floor).

Assuming, for example, the factory is located in Location A housing the machine(s) and the NPN AAA server 5 and the MNO HQ (“headquarter”) is located at Location B, wherein the distance between Location A and B is not adjacent (e.g. 50 km), housing core network entities such as the UPF entity, the AUSF entity 7 and the ARPF/UDM entity (this is for illustration purpose only and (5G) entities may be virtualized and hosted virtually anywhere).

Hence, it has been recognized that an authentication interface is required between the NPN AAA server 5 and the AUSF entity 7.

The AUSF entity 7 may be considered as one of the most secure entities and may then have to be exposed to each NPN 4 or factory NPN AAA server 5. The (5G) core network has an entity called NEF (“Network Exposure Function”) for the purpose of exposing different network entities. However, it has been recognized that security risks may exist for AUSF entity 7 exposure and the above-mentioned issue of transferring the EMSK from the NPN AAA server 5 to the AUSF entity 7 needs to be resolved.

Hence, some embodiments pertain to a user equipment for a mobile telecommunications system, including circuitry configured to:
communicate with a non-public network authentication-authorization-accounting server and initiate a registration procedure with the mobile telecommunications system; and
provide an authentication interface between the non-public network authentication-authorization-accounting server and an authentication server function entity in the mobile telecommunications system.

The user equipment may be or may include an electronic device, a smartphone, a VR device, a laptop or the like. The circuitry may include at least one of: a processor, a microprocessor, a dedicated circuit, a memory, a storage, a radio interface, a wireless interface, a network interface, or the like, e.g. typical electronic components which are included in a user equipment to achieve the functions as described herein. The user equipment includes credentials of a mobile telecommunications system, which may be based UMTS, LTE, LTE-A, or an NR, 5G system or the like.

The user equipment can communicate with the non-public network authentication-authorization-accounting (NPN AAA) server via the wireless or network interface which is generally known. In some embodiments, the user equipment is physically integrated in the NPN AAA server as an electronic component to achieve the functions as described herein.

The registration procedure may be any registration procedure typically performed in a mobile telecommunications system.

The authentication interface is logically located between the NPN AAA server and the AUSF entity in a core network and provides a secure logical and physical channel between the NPN AAA server and the AUSF entity. The user equipment is associated with the NPN AAA server in the mobile telecommunications system, which may include that any messages or data packets for the NPN AAA server from the mobile telecommunications system are transmitted over the authentication interface, i.e. the user equipment.

In some embodiments, a non-public network user equipment (NPN UE) located in the NPN transmits data packets via the authentication interface for authentication at the NPN AAA server. In some embodiments, the data packets include EAP data packets.

When the NPN AAA server is started or powered on or when the UE device is attached to the AAA server, the user equipment initiates the registration procedure with the mobile telecommunications system and ARPF/UDM and AUSF network entities. During the registration procedure, for example, the AUSF entity may be informed that this user equipment is a factory NPN AAA server.

Thus, in some embodiments, the user equipment signals the authentication server function entity an indication during the registration procedure with the mobile telecommunications system that the user equipment is associated with the non-public network authentication-authorization-accounting server for providing the authentication interface.

In some embodiments, the user equipment includes a special SIM card to identify it as associated to the NPN AAA server.

In some embodiments, the signaling is based on an access stratum signaling message or a non-access stratum signaling message.

These messages may be any AS or NAS message typically transmitted from the user equipment to the authentication server function entity and may be include one or more bits indicating the association to the NPN AAA server.

In some embodiments, the signaling is performed when the registration procedure is initiated.

In some embodiments, the signaling is performed when the user equipment and the authentication server function entity have established a security context.

In some embodiments, the signaling is performed when a security context has been established across all nodes.

The establishment of the security context may be based on any authentication method supported in the mobile telecommunications for authentication of a user equipment, such as (5G-)AKA, EAP-AK' or EAP-TLS. In some embodiments, an authentication method used in the registration procedure includes one of an authentication and key agreement protocol, an extensible authentication protocol-authentication and key agreement protocol’ and an extensible authentication protocol-transport layer security.

When the security context is established the user equipment and the AUSF entity have authenticated each other and ciphering keys and integrity protection keys for AS and NAS are in place.

Hence, in some embodiments, the authentication interface between the non-public network authentication-authorization-accounting server and the authentication server function entity is provided when the user equipment is authenticated and authorized as the user equipment associated with the non-public network authentication-authorization-accounting server in response to the signaling.

As mentioned above, in some embodiments, an (extended) master session key (“(E)MSK”) needs to be transferred in a secure way to the AUSF entity for further key derivation, since the (E)MSK is derived by the UE and the NPN AAA server. Hence, in such embodiments, an authentication interface between the NPN AAA server and the AUSF entity is required for the transfer.

Moreover, the problem about transferring the EMSK from the NPN AAA to the AUSF entity (in a secure way) for EAP-(T)TLS still exists for the cases where the user equipment associated with the NPN AAA server and a mobile telecommunications is used and where a wired internet-based connection is used.

Thus, the circuitry of the user equipment is further configured to:

transfer an extended master session key generated and encrypted by the non-public network authentication-authorization-accounting server to the authentication server function entity via the authentication interface.

In some embodiments, the physical path taken for transferring the EMSK from the NPN AAA server to the AUSF entity is:

NPN AAA server -> associated user equipment -> gNB -> UPF (or AMF (for Control Plane solution)) -> AUSF entity.

In such embodiments, the EMSK can be encrypted using the associated user equipment credentials. For example, the EMSK for a non-public network user equipment (note that this is not the user equipment associated with the NPN AAA server, but rather a user equipment which initiates authentication at the NPN AAA server) can be encrypted using the associated user equipment’s Kausf or CK/IK or RRCint, UPciph keys or a new key derived from CK/IK especially for this purpose and only valid for the associated user equipment only.

Accordingly, when the user equipment and the AUSF entity have established a security context, all keys are in place and credentials of the user equipment may be used to generate and encrypt the EMSK.

Hence, in some embodiments, the generated and encrypted extended master session key is encrypted based on a credential of the user equipment, wherein the credential is one of Kausf, CK/IK, RRCint and UPciph.

In some embodiments, the generated and encrypted extended master session key is encrypted based on a credential of the user equipment, wherein the credential is derived from CK/IK.

The authentication interface may be provided by a user plane function based solution, wherein EAP signaling messages (EAP data packets) may be treated as user plane data packets. Since EAP signaling messages may not be big in size, the existing network architecture may be maintained, whereby the security functions reside only on control plane (“CP”) path. The risk for CP solution may be that some of the messages may be interpreted by different nodes such as, for example, AMF (“Access Mobility Management Function”)/SMF (“Session Management Function”) entities and, thus, any EAP message encapsulated inside NAS message may be read by AMF/SMF entities.

Hence, in some embodiments, the authentication interface is provided via a user plane function of the mobile telecommunications system.

In some embodiments, extensible authentication protocol data packets transmitted via the authentication interface are treated as user plane data packets.

Moreover, in some embodiments, the circuitry of the user equipment is further configured to:

prohibit accessing any other data or other services offered by the mobile telecommunications system.

The user equipment may pass the received information (e.g. data packets or signaling messages) to the NPN AAA server and the NPN AAA server may act as an application sitting on top of the user equipment’s AS/NAS layers.

In some embodiments, the circuitry of the user equipment is further configured to:

transmit any received information from the mobile telecommunications system via the authentication interface to the associated non-public network authentication-authorization-accounting server.

In some embodiments, the received information includes extensible authentication protocol data packets from a non-public network user equipment located in a non-public network for authentication at the non-public network authentication-authorization-accounting server.

In some embodiments, the circuitry of the user equipment is further configured to:

determine an access point name in the registration procedure as the authentication server function entity or an authentication credential repository and processing function entity or a unified data management entity.

In some embodiments, the authentication interface supports a RADIUS or a DIAMETER protocol.

Generally, RADIUS may be less secure compared to DIAMETER. However, considering many legacy systems may be using RADIUS, it can be used due to the robustness provided by inherent 3GPP security.

In addition, there may be no need to support EAP-TTLS as 3GPP provides a secure tunnel.

According to the embodiments as described herein, some embodiments pertain to a non-public network authentication-authorization-accounting server, comprising circuitry configured to:
communicate with an associated user equipment for a mobile telecommunications system; and
receive information from the associated user equipment, wherein the associated user equipment received the data packets from the mobile telecommunications system via an authentication interface between the non-public network authentication-authorization-accounting server and an authentication server function entity in the mobile telecommunications system provided by the associated user equipment.

An authentication-authorization-accounting (“AAA”) server is generally known to the skilled person and, thus, a detailed description of it is omitted. The circuitry may include at least one of: a processor, a microprocessor, a dedicated circuit, a memory, a storage, a radio interface, a wireless interface, a network interface, or the like, e.g. typical electronic components which are included in an authentication-authorization-accounting server to achieve the functions as described herein.

The association of the user equipment with the NPN AAA server may be based on a predetermined ID (identification) known to both the user equipment and the NPN AAA server, a (special) SIM card for the user equipment which is known to the NPN AAA server, a predetermined message or key and the like exchanged during setup or operation or a predetermined communication path configuration or may be established by physically integrating the user equipment or the like.

As mentioned above, in some embodiments, once the user equipment is authenticated and authorized by the mobile telecommunications system and an authentication interface can be setup between the NPN AAA server and the AUSF entity via the user equipment functionality and data packets are transmitted to the NPN AAA server via the authentication interface and the user equipment.

In some embodiments, the information received from the associated user equipment include extensible authentication protocol data packets from a non-public network user equipment located in a non-public network for authentication at the non-public network authentication-authorization-accounting server.

In some embodiments, the circuitry of the non-public network authentication-authorization-accounting server is further configured to:

generate and encrypt an extended master session key based on a credential of the associated user equipment.

In some embodiments, the non-public network authentication-authorization-accounting server transmits the generated and encrypted extended master session key to the associated user equipment for transferring the generated and encrypted extended master session key to the authentication server function entity via the authentication interface.

As an example procedure for providing an authentication interface between an non-public network authentication-authorization server and an authentication server function entity:

The NPN AAA server powers up and communicates with an associated user equipment for initiating a provision of an authentication interface.

Then, the associated user equipment searches for operator network and camps on a suitable cell, which is shared between the NPN and the PLMN.

The associated user equipment initiates a registration procedure, i.e. RRC (“Radio Resource Control”) and NAS registration procedure and signals the core network that it is associated with the NPN AAA server.

A security procedure is initiated as for a typical user equipment and a key derivation starts while assuming the user equipment has a K value as a typical user equipment.

Then, the user equipment and the network, i.e. mobile telecommunications system, authenticate each other and ciphering and integrity protection keys for AS and NAS are in place.

Once the user equipment and the AUSF entity have established 5G security context, a new authentication interface is set up over the (5G) network. The responsibility of the physical node security of the NPN AAA server and the associated user equipment lies within the factory (as an example).

Generally, in some embodiments, some of the following advantages exist:
the MNO may be able to sell a special SIM card for the NPN AAA server and charge according to the factory business;
the AUSF entity is not exposed to internet and all traffic is carried over the operator network. The solution is scalable and allow multiple NPN AAA servers to be connected to the AUSF entity;
the factory owner (as an example) does not expose the machine credentials to the MNO and not tied to a single operator and free to choose the market;
legacy protocols such as RADIUS or DIAMTER can be supported; and
a support of EAP-TTLS may not be required.

According to the embodiments as described herein, some embodiments pertain to an authentication server function entity for a mobile telecommunications system, including circuitry configured to:
register a user equipment associated with a non-public network authentication-authorization-accounting server to the mobile telecommunications system; and
receive a signaling from the user equipment indicating that the user equipment is associated with the non-public network authentication-authorization-accounting server, wherein an authentication interface between the non-public network authentication-authorization-accounting server and the authentication server function entity is provided when the user equipment is authenticated and authorized as the user equipment associated with the non-public network authentication-authorization-accounting server in response to the signaling.

An authentication server function entity is generally known in a mobile telecommunications system and, thus, a detailed description of it is omitted. The circuitry may include at least one of: a processor, a microprocessor, a dedicated circuit, a memory, a storage, a radio interface, a wireless interface, a network interface, or the like, e.g. typical electronic components which are included in an authentication server function entity to achieve the functions as described herein.

In some embodiments, the circuitry of the authentication server function entity is further configured to:

receive an extended master session key generated and encrypted by the non-public network authentication-authorization-accounting server via the authentication interface, wherein the generated and encrypted extended master session key is encrypted based on a credential of the user equipment associated with the non-public network authentication-authorization-accounting server.

As mentioned above, the problem about transferring the EMSK from the NPN AAA to the AUSF entity (in a secure way) for EAP-(T)TLS still exists for the case where a wired (internet-based) connection (wired interface) is used.

For a wired interface there may be two options:

In some embodiments, the NPN AAA server is assigned an ID and this ID is known to both the NPN AAA server and AUSF entity. In such embodiments, the EMSK is encrypted using the NPN AAA server ID, which can be a certificate of the NPN AAA server.

Alternatively, in some embodiments, a PKI (“Public Key Infrastructure”) based solution, the AUSF entity sends a public key to the NPN AAA server and the AUSF entity holds the private key (e.g. in a memory or the like). In the NPN AAA server, the EMSK is encrypted using the public key of the AUSF entity. In the AUSF entity, it is decrypted with the private key.

Alternatively, in some embodiments, a pre-shared key (PSK) based solution, the MNO provides the secret key for this purpose, which could be separately stored in a special SIM card for the NPN AAA server. The SIM card may have memory capacity to store additional information and only authorized user may have access to it. Note that this is, in some embodiments, different from 3GPP pre-shared key (K) in SIM. In the NPN AAA server, the EMSK is encrypted using the secret key. In the AUSF entity, it is decrypted with the same secret key, which is configured by the MNO. In another embodiment, a NPN operator issues the secret key and stores it in a secure memory in the NPN AAA server. The NPN operator separately provides it to the MNO and the MNO stores it in the AUSF entity in advance.

Hence, some embodiments pertain to a non-public network authentication-authorization-accounting server, including circuitry configured to:
generate and encrypt an extended master session key based on a pre-shared non-public network authentication-authorization-accounting server ID of the non-public network authentication-authorization-accounting server; and
transfer the generated and encrypted extended master session key to an authentication server function entity via a wired interface.

Accordingly, some embodiments pertain to an authentication server function entity for a mobile telecommunications system, including circuitry configured to:
receive an extended master session key generated and encrypted by a non-public network authentication-authorization-accounting server via a wired interface; and
decrypt the encrypted extended master session key based on a pre-shared non-public network authentication-authorization-accounting server ID of the non-public network authentication-authorization-accounting server.

In some embodiments, the pre-shared non-public network authentication-authorization-accounting server ID is one of the key, an ID and a certificate of the non-public network authentication-authorization-accounting server.

Moreover, some embodiments pertain to an authentication server function entity for a mobile telecommunications system, comprising circuitry configured to:
generate a public key and a private key; and
transmit the public key to a non-public network authentication-authorization-accounting server via a wired interface, wherein the authentication server function entity holds the private key.

Accordingly, some embodiments pertain to a non-public network authentication-authorization-accounting server, including circuitry configured to:
receive a public key from an authentication server function entity;
generate and encrypt an extended master session key based on the received public key; and
transfer the extended master session key to the authentication server function entity via a wired interface.

In some embodiments, the circuitry of the authentication server function entity is further configured to:
receive via the wired interface an extended master session key generated and encrypted by the non-public network authentication-authorization-accounting server based on the public key; and
decrypt the received extended master session key based on the kept private key.

Moreover, some embodiments pertain to a non-public network authentication-authorization-accounting server, including circuitry configured to:
obtain a predetermined secret key stored in a secure memory in the non-public network authentication-authorization-accounting server in advance;
generate and encrypt an extended master session key based on the predetermined secret key; and
transfer the generated and encrypted master session key to an authentication server function entity via a wired interface.

As mentioned above, the secret key may be provided by a MNO or a NPN operator and may be exchanged between the MNO or the NPN operator in advance. The secret key may be stored in a secure memory in both the NPN AAA server and the AUSF entity. The secure memory may be a special SIM card for the NPN AAA server. The SIM card may have memory capacity to store additional information and only authorized user may have access to it (e.g. only the NPN AAA server). For the AUSF entity it may be a protected memory especially for the storage of secret keys of NPN operators or the like.

According to the embodiments as described herein, some embodiments pertain to an authentication server function entity for a mobile telecommunications system, including circuitry configured to:
obtain a predetermined secret key stored in a secure memory in the authentication server function entity in advance;
receive an extended master session key generated and encrypted by a non-public network authentication-authorization-accounting server via a wired interface; and
decrypt the encrypted extended master session key based on the predetermined secret key.

Returning to FIG. 2, which illustrates schematically a first embodiment of a mobile telecommunications system 1 including a non-public network 4 including a user equipment 9 in a state of establishing an authentication interface for the non-public network 4.

The mobile telecommunications system 1 is provided by a mobile network operator (“MNO”) and includes a NR radio access network (RAN) including a cell 2, which is established by an NR eNodeB 3 (also referred to as gNB(next generation eNodeB)).

In the cell 2, a non-public network (NPN) 4 is deployed, for example, in a factory, which can be, for example, established by a network slice, as mentioned above for non-standalone NPN. The NPN 4 hosts its own non-public network authentication-authorization-accounting (NPN AAA) server 5 for authentication of a non-public network user equipment (NPN UE) 6, which can be, for example, a machine. The NPN UE 6 can communicate with the gNB 3 in order to authenticate at the NPN AAA server 5 via an AUSF entity 7 in a core network 8.

Moreover, the NPN AAA server 5 communicates with an associated user equipment 9 (AAA UE). The AAA UE 9 communicates with the mobile telecommunications system 1 via the gNB 3 and initiated a registration procedure with the mobile telecommunications system 1 at the AUSF entity 7. During the registration procedure the AAA UE 9 signals the AUSF entity 7 that is associated with the NPN AAA server 5, as described herein, which is illustrated by the dash-dotted line carrying a message 10 (which may include one or more bits for the signaling) and the message 10 is an AS or NAS message and transmitted when a security context is established. In response to the signaling an authentication interface is provided between the NPN AAA server 5 and the AUSF entity 7 via the AAA UE 9.

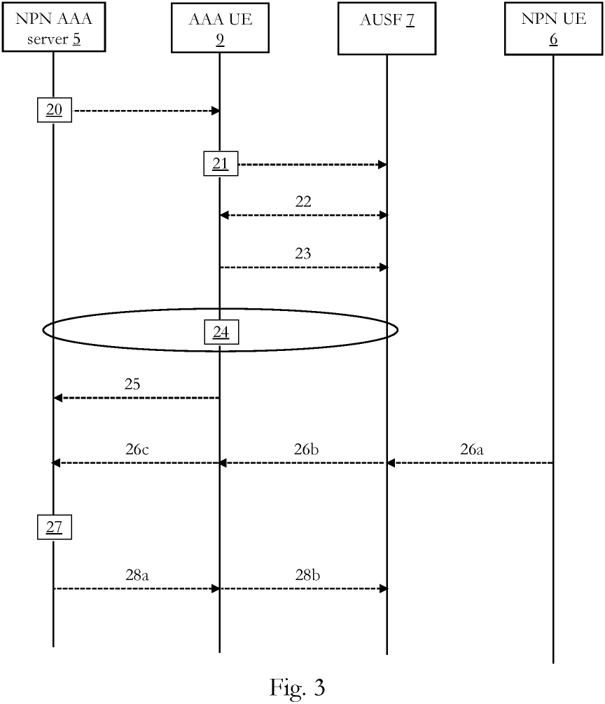

FIG. 3 illustrates in a state diagram an embodiment for providing an authentication interface for a non-public network 4.

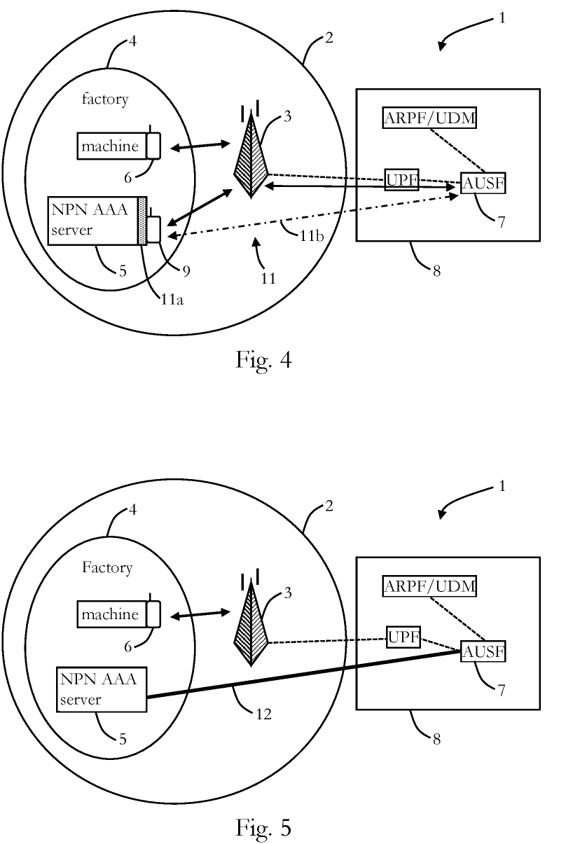

This embodiment is based on a deployment of a non-public network (NPN) 4 according to FIGS. 2 and 4.

At 20, the non-public network authentication-authorization-accounting (NPN AAA) server 5 powers up and communicates with an associated user equipment (AAA UE) 9 for initiating a provision of an authentication interface 11 (see FIG. 4) between the NPN AAA server 5 and an authentication server function (AUSF) entity 7 and the AAA UE 9 searches for operator network and camps on a suitable cell, i.e. the cell 2, which is shared between the NPN 4 and a PLMN.

In the following, the authentication interface 11 is divided for illustration purposes into an internal authentication interface 11a (between the NPN AAA server 5 and the AAA UE 9 illustrated by the dotted area between the NPN AAA server 5 and the AAA UE 9) and an external authentication interface 11b (between the AAA UE 9 and the AUSF entity 7 illustrated by the dashed-dotted line from the AAA UE 9 to the AUSF entity 7).

At 21, the AAA UE 9 initiates a registration procedure, i.e. RRC (“Radio Resource Control”) and NAS registration procedure, with the mobile telecommunications system, i.e. the AUSF entity 7.

At 22, the AAA UE 9 and AUSF entity 7 establish a security context, i.e. perform a security procedure, wherein the establishment of the security context is based on any authentication method supported in the mobile telecommunications for authentication of the AAA UE 9, such as (5G-)AKA, EAP-AKA’ or EAP-TLS, as described herein. The security procedure is initiated as for a typical user equipment for a mobile telecommunications system and a key derivation starts while assuming the AAA UE 9 has a K value as the typical user equipment. Then, the AAA UE 9 and the AUSF entity 7 authenticate each other and ciphering and integrity protection keys for AS and NAS are in place.

At 23, the AAA UE 9 signals the AUSF entity 7, when the security context is established, in an AS or NAS signaling message (which may be any message typically exchanged including one or more bits for the signaling that it is associated with the NPN AAA server 5).

Then, at 24, in response to the signaling an authentication interface 11 is provided between the NPN AAA server 5 and the AUSF entity 7 via the AAA UE 9. Moreover, the authentication interface 11 is provided via a user plane function of the mobile telecommunications system, so that EAP signaling messages are treated as user plane data packets.

At 25, the AAA UE 9 transmits a credential (one of Kausf, CK/IK, RRCint and UPciph) to the NPN AAA server 5 via the internal authentication interface 11a for generating and encrypting an extended master session key (EMSK) for a non-public network user equipment (NPN UE) 6 located in the NPN 4, for example, a machine including user equipment for a communication with the mobile telecommunications system and for authentication at the NPN AAA server 5.

At 26a, the NPN UE 6 (EAP peer) transmits an authentication request (data packets of an EAP signaling message) for authentication at the NPN AAA server 5 over the network via the user plane function, which is transparently forwarded at 26b by the AUSF entity 7 (EAP pass-through authenticator) to the AAA UE 9 via the external authentication interface 11b.

At 26c, the AAA UE 9 transmits the received information (data packets) including EAP data packets to the NPN AAA server 5 via the internal authentication interface 11a for authentication of the NPN UE 6 at the NPN AAA server 5.

At 27, the NPN AAA server 5 generates and encrypts the EMSK based on a credential of AAA UE 9 (the NPN AAA server 5 holds the credentials of the NPN UE 6 for authentication).

At 28a and 28b, the generated and encrypted EMSK is transferred to the AUSF entity 7 via the authentication interface 11 between the NPN AAA server 5 and the AUSF entity 7 provided by the AAA UE 9.

FIG. 4 illustrates schematically a second embodiment of a mobile telecommunications system 1 including a non-public network (NPN) 4 including a user equipment (AAA UE) 9 for providing an authentication interface 11 for the NPN 4.

This embodiment is based on the embodiment of FIG. 2 and illustrates the new logical and physical authentication interface 11 between the NPN AAA server 5 and the AUSF entity 7 via the AAA UE 9. The arrow with dash-dotted line shows the logical authentication interface 11 and the arrow with solid lines show the actual (physical) path in the authentication interface 11. The authentication interface 11 is divided for illustration purposes into an internal authentication interface 11a (between the NPN AAA server 5 and the AAA UE 9 illustrated by the dotted area between the NPN AAA server 5 and the AAA UE 9) and an external authentication interface 11b (between the AAA UE 9 and the AUSF entity 7 illustrated by the dashed-dotted line from the AAA UE 9 to the AUSF entity 7).

FIG. 5 illustrates schematically an embodiment of a mobile telecommunications system 1a including a non-public network (NPN) 4 including a wired interface 12 between a non-public network authentication-authorization-accounting (NPN AAA) server 5 and an authentication server function (AUSF) entity 7.

This embodiment is based on the embodiment of FIG. 1 except that the NPN AAA server 5 is physically connected via a wired interface 12 (e.g. an internet-based connection) to the AUSF entity 7.

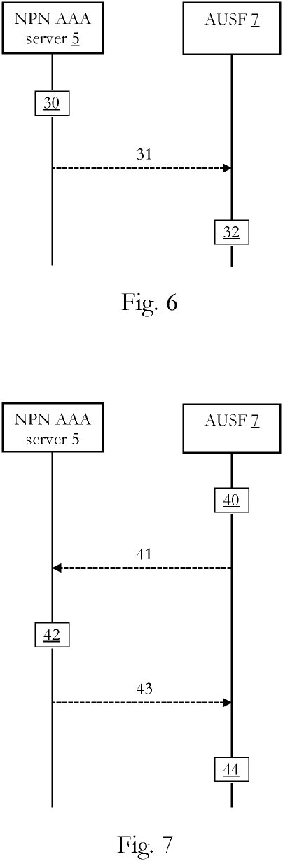

FIG. 6 illustrates in a state diagram a first embodiment of a transfer of an extended master session key (EMSK) from a non-public network authentication-authorization-accounting (NPN AAA) server 5 to an authentication server function (AUSF) entity 7 via a wired interface 12.

This embodiment is based on a deployment of a non-public network (NPN) 4 according to FIG. 5.

At 30, the NPN AAA server 5 generates and encrypts an EMSK based on a pre-shared NPN AAA server ID of the NPN AAA server 5, wherein the pre-shared NPN AAA ID is one of a key, an ID and a certificate of the NPN AAA server 5.

At 31, the NPN AAA server 5 transfers the generated and encrypted EMSK to an AUSF entity 7 via a wired interface 12.

At 32, the AUSF entity 7 receives the EMSK via the wired interface 12 and decrypts the EMSK based on the pre-shared NPN AAA server ID of the NPN AAA server 5.

In an alternative embodiment, the NPN AAA server 5 obtains, at 30, a predetermined secret key stored in a secure memory in the NPN AAA server 5 in advance (e.g. the secret key is loaded from a special SIM card for the NPN AAA server 5). Moreover, the NPN AAA server 5 generates and encrypts an EMSK based on the predetermined secret key.

At 31, the NPN AAA server 5 transfers the generated and encrypted master session key to the AUSF entity 7 via the wired interface 12.

At 32, the AUSF entity 7 obtains the predetermined secret key stored in a secure memory in the AUSF entity 7 in advance (e.g. the secret key is loaded from a protected memory in the AUSF entity 7). Moreover, the AUSF entity 7 receives the EMSK generated and encrypted by the NPN AAA server 5 via the wired interface 12 and decrypts the EMSK based on the predetermined secret key.

FIG. 7 illustrates in a state diagram a second embodiment of a transfer of an extended master session key (EMSK) from a non-public network authentication-authorization-accounting (NPN AAA) server 5 to an authentication server function (AUSF) entity 7 via a wired interface 12.

This embodiment is based on a deployment of a non-public network (NPN) 4 according to FIG. 5.

At 40, the AUSF entity 7 generates a public key and a private key.

At 41, the AUSF entity 7 transmit the public key to a NPN AAA server via a wired interface 12, wherein the AUSF entity 7 holds the private key (in a memory).

At 42, the NPN AAA server 5 receives the public key from the AUSF entity 7 and generates and encrypt an EMSK based on the received public key.

At 43, the NPN AAA server 5 transfers the EMSK to the AUSF entity 7 via the wired interface 12.

At 44, the AUSF entity 7 receives the EMSK via the wired interface 12 and decrypts the received EMSK based on the held private key.

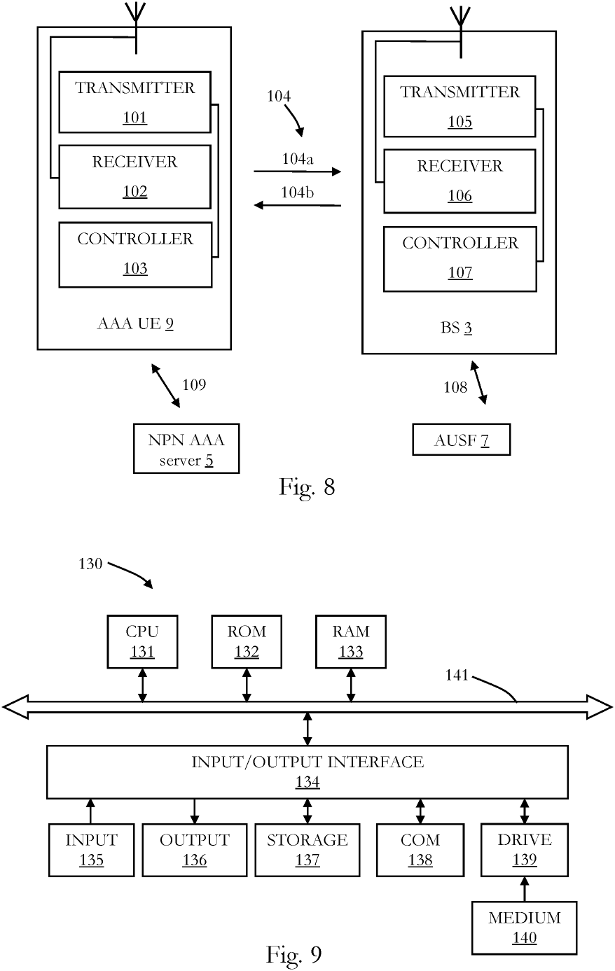

An embodiment of a user equipment (AAA UE) 9, a base station (BS) 3 (e.g. NR eNB/gNB), a communication path 104 between the AAA UE 9 and the BS 3, an authentication server function (AUSF) entity 7, a communication path 108 between the BS 3 and the AUSF entity 7 (the BS 3 may not directly connect to the AUSF entity, but for illustration purposes the communication path 108 is illustrated as being a direct connection), a non-public network authentication-authorization-accounting (NPN AAA) server 5, and a communication path 109 between the NPN AAA server 5 and the AAA UE 9, which is used for implementing embodiments of the present disclosure, is discussed under reference of FIG. 8.

The AAA UE 9 has a transmitter 101, a receiver 102 and a controller 103, wherein, generally, the technical functionality of the transmitter 101, the receiver 102 and the controller 103 are known to the skilled person, and, thus, a more detailed description of them is omitted.

The BS 3 has a transmitter 105, a receiver 106 and a controller 107, wherein also here, generally, the functionality of the transmitter 105, the receiver 106 and the controller 107 are known to the skilled person, and, thus, a more detailed description of them is omitted.

The communication path 104 has an uplink path 104a, which is from the AAA UE 9 to the BS 3, and a downlink path 104b, which is from the BS 3 to the AAA UE 9.

During operation, the controller 103 of the AAA UE 9 controls the reception of downlink signals over the downlink path 104b at the receiver 102 and the controller 103 controls the transmission of uplink signals over the uplink path 104a via the transmitter 101.

Similarly, during operation, the controller 107 of the BS 3 controls the transmission of downlink signals over the downlink path 104b over the transmitter 105 and the controller 107 controls the reception of uplink signals over the uplink path 104a at the receiver 106.

The BS 3 can communicate with the AUSF entity 7 via the communication path 108, which can be provided by a network interface typically used for such a communication. As such a communication over a network interface is known to the skilled person, a more detailed description of it is omitted.

The NPN AAA server 5 can communicate with the AAA UE 9 via the communication path 109, which can be provided by a network interface typically used for such a communication. As such a communication over a network interface is known to the skilled person, a more detailed description of it is omitted.

FIG. 9 illustrates in a block diagram a multi-purpose computer 130 which can be used for implementing a user equipment, a base station, a non-public network authentication-authorization-accounting server and an authentication server function entity.

The computer 130 can be implemented such that it can basically function as any type of user equipment, base station or new radio base station, transmission and reception point, or non-public network authentication-authorization-accounting server, or authentication server function entity as described herein. The computer has components 131 to 141, which can form a circuitry, such as any one of the circuitries of the base stations, and user equipments, and the like as described herein.

Embodiments which use software, firmware, programs or the like for performing the methods as described herein can be installed on computer 130, which is then configured to be suitable for the concrete embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station or as user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, etc.

It should be noted that the description above only pertains to an example configuration of computer 130. Alternative configurations may be implemented with additional or other sensors, storage devices, interfaces or the like. For example, the communication interface 138 may support other radio access technologies than the mentioned UMTS, LTE and NR.

When the computer 130 functions as a base station, the communication interface 138 can further have a respective air interface (providing e.g. E-UTRA protocols OFDMA (downlink) and SC-FDMA (uplink)) and network interfaces (implementing for example protocols such as S1-AP, GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

A user equipment for a mobile telecommunications system, including circuitry configured to:
communicate with a non-public network authentication-authorization-accounting server and initiate a registration procedure with the mobile telecommunications system; and
provide an authentication interface between the non-public network authentication-authorization-accounting server and an authentication server function entity in the mobile telecommunications system.

The user equipment of (1), wherein the user equipment signals the authentication server function entity an indication during the registration procedure with the mobile telecommunications system that the user equipment is associated with the non-public network authentication-authorization-accounting server for providing the authentication interface.

The user equipment of (2), wherein the signaling is based on an access stratum signaling message or a non-access stratum signaling message.

The user equipment of (2) or (3), wherein the signaling is performed when the user equipment and the authentication server function entity have established a security context.

The user equipment of (4), wherein the authentication interface between the non-public network authentication-authorization-accounting server and the authentication server function entity is provided when the user equipment is authenticated and authorized as the user equipment associated with the non-public network authentication-authorization-accounting server in response to the signaling.

The user equipment of anyone of (1) to (5), wherein the circuitry is further configured to:

transfer an extended master session key generated and encrypted by the non-public network authentication-authorization-accounting server to the authentication server function entity via the authentication interface.

The user equipment of (6), wherein the generated and encrypted extended master session key is encrypted based on a credential of the user equipment, wherein the credential is one of Kausf, CK/IK, RRCint and UPciph.

The user equipment of (6) or (7), wherein the generated and encrypted extended master session key is encrypted based on a credential of the user equipment, wherein the credential is derived from CK/IK.

The user equipment of anyone of (1) to (8), wherein the authentication interface is provided via a user plane function of the mobile telecommunications system.

The user equipment of (9), wherein extensible authentication protocol data packets transmitted via the authentication interface are treated as user plane data packets.

The user equipment of anyone of (1) to (10), wherein the authentication interface supports a RADIUS or a DIAMETER protocol.

The user equipment of anyone of (1) to (11), wherein an authentication method used in the registration procedure includes one of a authentication and key agreement protocol, an extensible authentication protocol-authentication and key agreement protocol’ and an extensible authentication protocol-transport layer security.

The user equipment of anyone of (1) to (12), wherein the circuitry is further configured to:

determine an access point name in the registration procedure as the authentication server function entity or an authentication credential repository and processing function entity or a unified data management entity.

The user equipment of anyone of (1) to (13), wherein the circuitry is further configured to:

prohibit accessing any other data or other services offered by the mobile telecommunications system.

The user equipment of anyone of (1) to (14), wherein the circuitry is further configured to:

transmit any received information from the mobile telecommunications system via the authentication interface to the associated non-public network authentication-authorization-accounting server.

The user equipment of (15), wherein the received information includes extensible authentication protocol data packets from a non-public network user equipment located in a non-public network for authentication at the non-public network authentication-authorization-accounting server.

The user equipment of anyone of (2) to (16), wherein the signaling is performed when a security context has been established across all nodes.

A non-public network authentication-authorization-accounting server, including circuitry configured to:
communicate with an associated user equipment for a mobile telecommunications system; and
receive information from the associated user equipment, wherein the associated user equipment received the data packets from the mobile telecommunications system via an authentication interface between the non-public network authentication-authorization-accounting server and an authentication server function entity in the mobile telecommunications system provided by the associated user equipment.

The non-public network authentication-authorization-accounting server of (18), wherein the information received from the associated user equipment include extensible authentication protocol data packets from a non-public network user equipment located in a non-public network for authentication at the non-public network authentication-authorization-accounting server.

The non-public network authentication-authorization-accounting server of (18) or (19), wherein the circuitry is further configured to:

generate and encrypt an extended master session key based on a credential of the associated user equipment.

The non-public network authentication-authorization-accounting server of (20), wherein the non-public network authentication-authorization-accounting server transmits the generated and encrypted extended master session key to the associated user equipment for transferring the generated and encrypted extended master session key to the authentication server function entity via the authentication interface.

A non-public network authentication-authorization-accounting server, including circuitry configured to:
generate and encrypt an extended master session key based on a pre-shared non-public network authentication-authorization-accounting server ID of the non-public network authentication-authorization-accounting server; and
transfer the generated and encrypted extended master session key to an authentication server function entity via a wired interface.

The non-public network authentication-authorization-accounting server of (22), wherein the pre-shared non-public network authentication-authorization-accounting server ID is one of a key, an ID and a certificate of the non-public network authentication-authorization-accounting server.

A non-public network authentication-authorization-accounting server, including circuitry configured to:
receive a public key from an authentication server function entity;
generate and encrypt an extended master session key based on the received public key; and
transfer the extended master session key to the authentication server function entity via a wired interface.

A non-public network authentication-authorization-accounting server, including circuitry configured to:
obtain a predetermined secret key stored in a secure memory in the non-public network authentication-authorization-accounting server in advance;
generate and encrypt an extended master session key based on the predetermined secret key; and
transfer the generated and encrypted extended master session key to an authentication server function entity via a wired interface.

An authentication server function entity for a mobile telecommunications system, including circuitry configured to:
register a user equipment associated with a non-public network authentication-authorization-accounting server to the mobile telecommunications system; and
receive a signaling from the user equipment indicating that the user equipment is associated with the non-public network authentication-authorization-accounting server, wherein an authentication interface between the non-public network authentication-authorization-accounting server and the authentication server function entity is provided when the user equipment is authenticated and authorized as the user equipment associated with the non-public network authentication-authorization-accounting server in response to the signaling.

The authentication server function entity of (26), wherein the circuitry is further configured to:

receive an extended master session key generated and encrypted by the non-public network authentication-authorization-accounting server via the authentication interface, wherein the generated and encrypted extended master session key is encrypted based on a credential of the user equipment associated with the non-public network authentication-authorization-accounting server.

An authentication server function entity for a mobile telecommunications system, including circuitry configured to:
receive an extended master session key generated and encrypted by a non-public network authentication-authorization-accounting server via a wired interface; and
decrypt the encrypted extended master session key based on a pre-shared non-public network authentication-authorization-accounting server ID of the non-public network authentication-authorization-accounting server.

The authentication server function entity of (28), wherein the pre-shared non-public network authentication-authorization-accounting ID is one of a key, an ID and a certificate of the non-public network authentication-authorization-accounting server.

An authentication server function entity for a mobile telecommunications system, including circuitry configured to:
generate a public key and a private key; and
transmit the public key to a non-public network authentication-authorization-accounting server via a wired interface, wherein the authentication server function entity holds the private key.

The authentication server function entity of (30), wherein the circuitry is further configured to:
receive via the wired interface an extended master session key generated and encrypted by the non-public network authentication-authorization-accounting server based on the public key; and
decrypt the received extended master session key based on the held private key.

An authentication server function entity for a mobile telecommunications system, including circuitry configured to:
obtain a predetermined secret key stored in a secure memory in the authentication server function entity in advance;
receive an extended master session key generated and encrypted by a non-public network authentication-authorization-accounting server via a wired interface; and
decrypt the encrypted extended master session key based on the predetermined secret key.

1. A user equipment for a mobile telecommunications system, comprising circuitry configured to:
communicate with a non-public network authentication-authorization-accounting server and initiate a registration procedure with the mobile telecommunications system; and
provide an authentication interface between the non-public network authentication-authorization-accounting server and an authentication server function entity in the mobile telecommunications system.

2. The user equipment according to claim 1, wherein the user equipment signals the authentication server function entity an indication during the registration procedure with the mobile telecommunications system that the user equipment is associated with the non-public network authentication-authorization-accounting server for providing the authentication interface.

3. The user equipment according to claim 2, wherein the signaling is based on an access stratum signaling message or a non-access stratum signaling message.

4. The user equipment according to claim 2, wherein the signaling is performed when the user equipment and the authentication server function entity have established a security context.

5. The user equipment according to claim 4, wherein the authentication interface between the non-public network authentication-authorization-accounting server and the authentication server function entity is provided when the user equipment is authenticated and authorized as the user equipment associated with the non-public network authentication-authorization-accounting server in response to the signaling.

6. The user equipment according to claim 1, wherein the circuitry is further configured to:
transfer an extended master session key generated and encrypted by the non-public network authentication-authorization-accounting server to the authentication server function entity via the authentication interface.

7. The user equipment according to claim 6, wherein the generated and encrypted extended master session key is encrypted based on a credential of the user equipment, wherein the credential is one of Kausf, CK/IK, RRCint and UPciph.

8. The user equipment according to claim 6, wherein the generated and encrypted extended master session key is encrypted based on a credential of the user equipment, wherein the credential is derived from CK/IK.

9. The user equipment according to claim 1, wherein the authentication interface is provided via a user plane function of the mobile telecommunications system.

10. The user equipment according to claim 9, wherein extensible authentication protocol data packets transmitted via the authentication interface are treated as user plane data packets.

11. The user equipment according to claim 1, wherein the authentication interface supports a RADIUS or a DIAMETER protocol.

12. The user equipment according to claim 1, wherein an authentication method used in the registration procedure includes one of a authentication and key agreement protocol, an extensible authentication protocol-authentication and key agreement protocol’ and an extensible authentication protocol-transport layer security.

13. The user equipment according to claim 1, wherein the circuitry is further configured to:
determine an access point name in the registration procedure as the authentication server function entity or an authentication credential repository and processing function entity or a unified data management entity.

14. The user equipment according to claim 1, wherein the circuitry is further configured to:
prohibit accessing any other data or other services offered by the mobile telecommunications system.

15. The user equipment according to claim 1, wherein the circuitry is further configured to:
transmit any received information from the mobile telecommunications system via the authentication interface to the associated non-public network authentication-authorization-accounting server.

16. The user equipment according to claim 15, wherein the received information includes extensible authentication protocol data packets from a non-public network user equipment located in a non-public network for authentication at the non-public network authentication-authorization-accounting server.

17. The user equipment according to claim 2, wherein the signaling is performed when a security context has been established across all nodes.

18-24. (canceled)

25. A non-public network authentication-authorization-accounting server, comprising circuitry configured to:
obtain a predetermined secret key stored in a secure memory in the non-public network authentication-authorization-accounting server in advance;
generate and encrypt an extended master session key based on the predetermined secret key; and
transfer the generated and encrypted extended master session key to an authentication server function entity via a wired interface.

26. An authentication server function entity for a mobile telecommunications system, comprising circuitry configured to:
register a user equipment associated with a non-public network authentication-authorization-accounting server to the mobile telecommunications system; and
receive a signaling from the user equipment indicating that the user equipment is associated with the non-public network authentication-authorization-accounting server, wherein an authentication interface between the non-public network authentication-authorization-accounting server and the authentication server function entity is provided when the user equipment is authenticated and authorized as the user equipment associated with the non-public network authentication-authorization-accounting server in response to the signaling.

27. The authentication server function entity according to claim 26, wherein the circuitry is further configured to:
receive an extended master session key generated and encrypted by the non-public network authentication-authorization-accounting server via the authentication interface, wherein the generated and encrypted extended master session key is encrypted based on a credential of the user equipment associated with the non-public network authentication-authorization-accounting server.

28-32. (canceled)
